(19) United States
(12) Patent Application Publication
(10) Pub. No.: US 2020/0213446 A1
(43) Pub. Date: Jul. 2, 2020

(54) SYSTEM AND METHOD FOR COMPUTER-IMPLEMENTED AUTOMATED ASSISTANCE INCLUDING INTERACTIVE ENCLOSURE UNLOCKING

(71) Applicant: TELEPERFORMANCE SE, Paris (FR)

(72) Inventors: Lyle HARDY, Holladay, UT (US); Evan DAVIS, Santaquin, UT (US)

(21) Appl. No.: 16/730,783

(22) Filed: Dec. 30, 2019

Related U.S. Application Data
(60) Provisional application No. 62/786,766, filed on Dec. 31, 2018.

(51) Int. Cl. H04M 3/51; G06Q 30/00; G07C 9/38

(52) U.S. Cl. CPC H04M 3/5183; G07C 9/38; G06Q 30/016

(57) ABSTRACT

Embodiments of the present invention provide systems and methods for unlocking and locking enclosures or lockers of a customer service center, for example, responsive to a real-time customer-agent interaction. One disclosed method includes using a remote server to determine a solution to a user request, where the solution includes an identification of a selected locker of a plurality of lockers located at the customer service center, and using the remote server to communicate the selected locker identification and an unlock code to the user via the customer service session of the computer system, where the selected locker includes equipment for the user to satisfy the user request.

### CROSS-REFERENCE TO RELATED APPLICATION

This application claims the benefit of U.S. Provisional Patent Application No. 62/786,766 filed Dec. 31, 2018, entitled “SYSTEM AND METHOD FOR COMPUTER-IMPLEMENTED AUTOMATED ASSISTANCE INCLUDING INTERACTIVE ENCLOSURE UNLOCKING,” by Lyle Hardy et al., which is hereby incorporated by reference.

### FIELD

Embodiments of the present invention generally relate to the fields of equipment and inventory management. More specifically, embodiments of the present invention relate to computer-implemented systems and methods for providing assistance to customers or employees for managing equipment in an automated way.

### BACKGROUND

Customer service issues at a customer care facility often are related to damaged or defective equipment (e.g., a modem, cable box, or other consumer electronic device) that must be repaired or replaced at a customer service center. In a typical case, the customer returns a defective item and obtains a new item to replace the old item. In other cases, the customer simply wishes to obtain new equipment or return old equipment that is no longer needed.

It is often desirable to obtain a device or piece of equipment that requires authorization in an automated way. For example, in the context of a customer service center, a customer may which to obtain a new piece of equipment to satisfy a customer service issue. Typically a user must check-in at a reception desk, identify themselves and their customer service issue, and wait until an agent is available to assist them. Customer service centers often have long wait times before a customer can be assisted by an available customer service agent. Therefore, an automated approach to satisfying customer service issues, for example, by automatically dispensing or accepting equipment would improve the customer experience.

Moreover, equipment used by employees is typically secured in a locked room or locker, and the locked room or locker must be manually unlocked before an employee can access the requisite device or equipment. The employee may also be required to manually indicate on a log sheet when they obtained the device and when the device was returned. The existing approach can be improved by an automated system and method for dispensing and tracking employee equipment.

### SUMMARY

Embodiments of the present invention provide systems and methods for automated unlocking and locking enclosures or lockers. For example, lockers can be automatically locked and/or unlocked responsive in a customer service center responsive to a real-time customer-agent interaction. Some embodiments are useful in the context of an inventory management system where agents can check-out equipment from electronically managed enclosures.

According to one embodiment, a method of responding to a user request is disclosed. The method includes using a remote server to instantiate a customer service session with the user on a computer system located at a customer service center, where the customer service session is a software application rendering a user interface on the computer system, the user interface including a real-time displayed image and an audio rendering of a customer assistant, responding to user input at the computer system, where the user input includes an identification of the user, an identification of a user account associated with the user, and the user request, and communicating information regarding the user request to the remote server. The method further includes using the remote server to determine a solution to the user request, where the solution includes an identification of a selected locker of a plurality of lockers located at the customer service center, and using the remote server to communicate the selected locker identification and an unlock code to the user via the customer service session of the computer system, where the selected locker includes equipment for the user to satisfy the user request.

According to some embodiments, the computer system is a kiosk located within the customer service center.

According to some embodiments, the computer system is a mobile device associated with the user.

According to some embodiments, the unlock code is a combination code to a lock associated with the selected locker.

According to some embodiments, using the remote server to determine a solution to the user request includes determining a required equipment that satisfies the user request, and determining the selected locker by scanning contents of the plurality of lockers to locate a locker containing the required equipment, where the contents of the plurality of lockers are represented in a locker contents database of the remote server.

According to some embodiments, the method further includes receiving identifications of the new equipment and the particular locker at the remote server and storing the identifications into the locker contents database of the remote server responsive to new equipment being placed into a particular locker of the plurality of lockers.

According to some embodiments, the solution further includes an identification of old equipment of the user to be placed into the selected locker by the user and further includes the remote server communicating to a representative at the customer service center the identification of the old equipment, an identification of the selected locker, and a work task to verify that the old equipment is present in the selected locker.

According to some embodiments, the remote server includes a user account database including a plurality of user accounts.

According to another embodiment, a method of servicing a customer request is disclosed. The method includes using a remote server to initiate a customer service session with a customer on a computer system located at a customer service center, where the customer service session is a software application performing rendering a user interface on the computer system, the user interface including a real-time displayed image and an audio rendering of a customer assistant, responding to user input at the computer system, where the user input includes an identification of the customer, an identification of a customer account associated with the customer, and the customer request, and communicating information regarding the customer request to the remote server. The method further includes using the remote server to determine a solution to the customer request responsive to the customer request and information gathered from the customer account, where the solution includes an identification of a selected locker of a plurality of lockers located at the customer service center, using the remote server to communicate the selected locker identification to the customer via the customer service session, and using the remote server to automatically unlock the selected locker of the plurality of lockers where the selected locker includes equipment for the customer to satisfy the customer request.

According to a different embodiment, a system to facilitate servicing a customer request is disclosed. The system includes a remote server, a plurality of lockable lockers located within a customer service center, the plurality of lockable lockers in communication with the remote server, a computer system in communication with the remote server and located at the customer service center, where the remote server is operable to initiate a customer service session with a customer on the computer system, where the customer service session is a software application performing rendering a user interface on the computer system, the user interface including a real-time displayed image and an audio rendering of a customer assistant, responding to user input at the computer system, where the user input includes an identification of the customer, an identification of a customer account associated with the customer, and the customer request, and communicating information regarding the customer request to the remote server. The remote server is operable to determine a solution to the customer request responsive to the customer request and information gathered from the customer account, where the solution includes an identification of a selected locker of a plurality of lockers located at the customer service center, where the remote server is also operable to communicate the selected locker identification to the customer via the customer service session, and where further the remote server is operable to automatically unlock the selected locker of the plurality of lockers and where the selected locker includes equipment for the customer to satisfy the customer request.

According to some embodiments, the computer system is a kiosk located within the customer service center.

According to some embodiments, the computer system is a mobile device associated with the customer

According to some embodiments, the remote server is operable to determine a solution to the customer request by determining a required equipment that satisfies the customer request, and determining the selected locker by scanning contents of the plurality of lockers to locate a locker containing the required equipment, where the contents of the plurality of lockers are represented in a locker contents database of the remote server.

According to some embodiments, the solution further includes an identification of old equipment of the customer to be placed into the selected locker by the customer where the remote server is operable to communicate to a representative at the customer service center the identification of the old equipment, an identification of the selected locker, and a work task to verify that the old equipment is present in the selected locker.

According to another embodiment, a system to dispense and track devices is disclosed. The system includes a remote server, a plurality of lockable lockers, said plurality of lockable lockers in communication with the remote server, and a computer system comprising an input device, where the computer system is in communication with the remote server, where the remote server is operable to validate user credentials and store a status of a plurality of devices stored in the plurality of lockable lockers. The computer system is operable to receive user credentials from the input device, transmit the user credentials to the remote server for verification, automatically unlock a first locker of the plurality of lockable lockers responsive to the remote server successfully verifying the user credentials, transmit a first status of the device to the remote server, where the first status indicates that the device has been dispensed, automatically determine that the device has been returned, transmit a second status of the device to the remote server, where the second status indicates that the device has been returned, and automatically lock the first locker responsive to determining that the device has been returned.

According to another embodiment, a method of automatically tracking and dispensing a device is disclosed. The method includes receiving user credentials from an input device, transmitting the user credentials to a remote server for verification, automatically unlocking a locker responsive to the remote server successfully verifying the user credentials, transmitting a first status of the device to the remote server, where the first status indicates that the device has been dispensed, automatically determining that the device has been returned, transmitting a second status of the device to the remote server, where the second status indicates that the device has been returned, and automatically locking the locker responsive to determining that the device has been returned.

According to some embodiments, the method includes determining that the device has been plugged into a cable disposed in the locker to determine that the device has been returned.

According to some embodiments, the method includes storing a timestamp indicating when the device was dispensed and storing a timestamp indicating when the device was returned.

According to some embodiments, the method includes automatically changing an unlock code used to lock the locker.

According to some embodiments, the method includes displaying a locker identification of the locker and a corresponding unlock code on a display device responsive to the remote server successfully verifying the user credentials, and receiving the unlock code at a digital keypad of the locker.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A is a flow chart depicting an exemplary sequence of computer-implemented steps for authorizing access to and unlocking an enclosure, such as a locker located in a customer service center, according to embodiments of the present invention.

FIG. 1B is a flow chart depicting an exemplary sequence of computer-implemented steps for automated unlocking and locking of an enclosure to dispense an item and/or to accept an item from a user according to embodiments of the present invention.

FIG. 2 is a block diagram of an exemplary customer service center for providing real-time customer service so that customers can return or retrieve items or equipment according to embodiments of the present invention.

FIG. 3A is a flow chart of an exemplary sequence of computer-implemented steps for automated unlocking of an equipment locker and tracking contents stored therein according to embodiments of the present invention.

FIG. 3B is a flow chart depicting an exemplary sequence of computer-implemented steps for unlocking an equipment locker responsive to an unlock code entered at the locker and tracking contents stored therein according to embodiments of the present invention.

FIG. 4A is a block diagram of an exemplary equipment management system for managing equipment lockers depicted according to embodiments of the present invention.

FIG. 4B depicts an exemplary locked locker that can be automatically unlocked for dispensing equipment according to embodiments of the present invention.

FIG. 4C depicts an exemplary unlocked locker that can be automatically locked according to embodiments of the present invention.

FIG. 5 is a block diagram of an exemplary computer system upon which embodiments of the present invention may be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

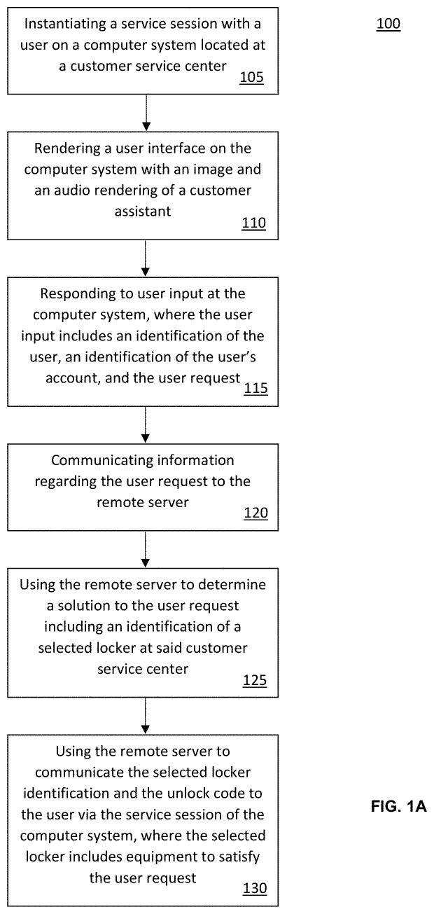

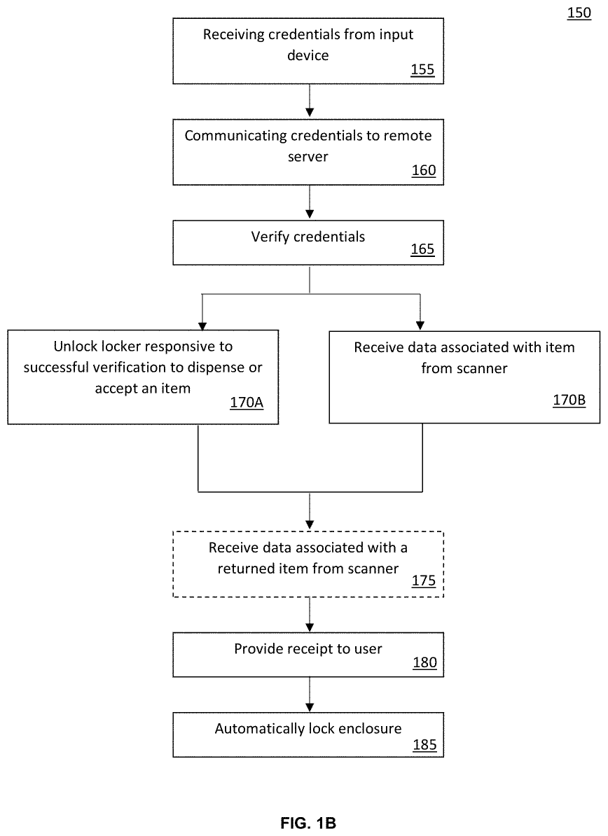

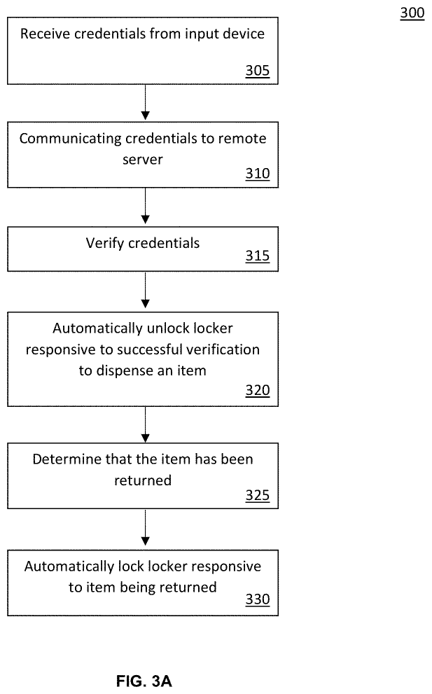

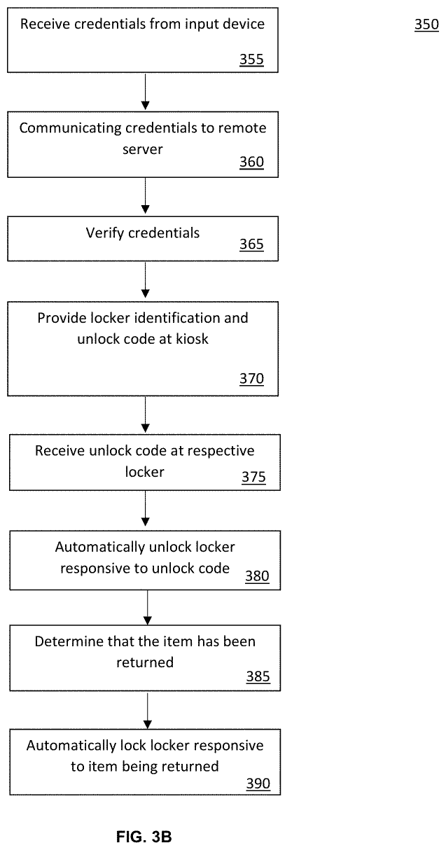

Portions of the detailed description that follow are presented and discussed in terms of a method. Although steps and sequencing thereof are disclosed in a figure herein (e.g., FIGS. 1A, 1B, 3A, and 3B) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “determining,” “including,” “storing,” “transmitting,” “associating,” “identifying,” “encoding,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Interactive Authorization and Unlocking of Locker or Enclosure for Equipment Dispensing and Returns

Embodiments of the present invention provide systems and methods for automated unlocking and locking enclosures or lockers. For example, lockers can be automatically locked and/or unlocked responsive in a customer service center responsive to a real-time customer-agent interaction. Some embodiments are useful in the context of an inventory management system where agents can check-out equipment from electronically managed enclosures.

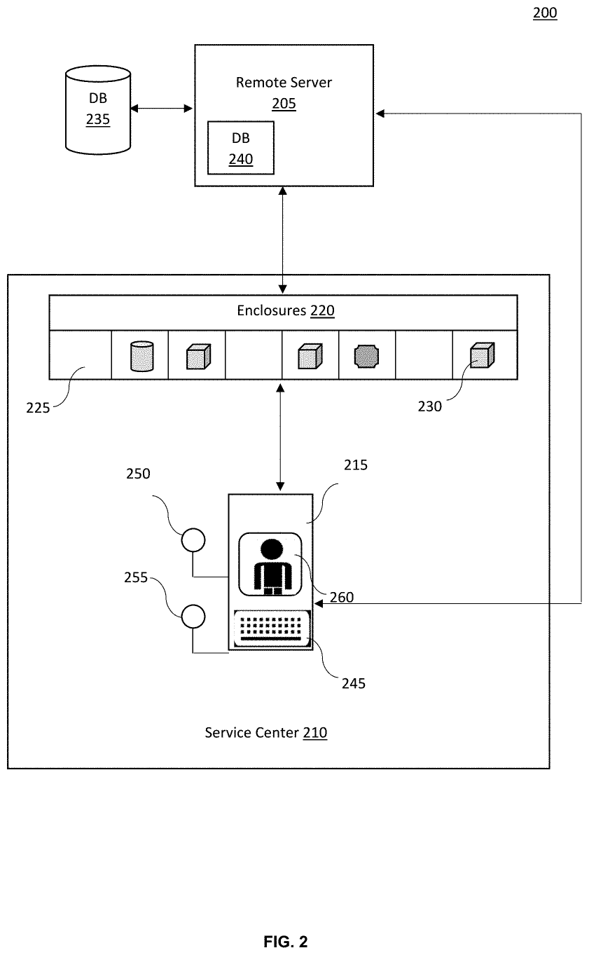

With regard to FIG. 1A, an exemplary sequence of computer-implemented steps 100 for automated unlocking and locking of an enclosure responsive to a user-agent interaction is depicted according to embodiments of the present invention. The steps 100 can be executed by an equipment management system, such as the system 200 depicted in FIG. 2, for example.

At step 105 of FIG. 1A, a service session is instantiated with a user on a computer system located, for example, at a user service center using a local or remote server. A user interface is rendered on the computer system that includes an audio and/or visual representation of a customer service agent at step 110. The user interface may be used to provide a text chat, a video chat, or a voice call for example, between the user and the agent.

At step 115, user input is received at the computer system and responded to by the agent, where the user input includes, for example, an identification of the user, an identification of the user's account, and the user request (e.g., a user service request e.g., for equipment). Information regarding the user request is communicated to the remote server at step 120. The user input can include information related to a piece equipment obtained by scanning a barcode on the equipment that specifically identifies the equipment (e.g., model number, serial number, version number, etc.) or by a selection from an on-screen display of choices. The computer system can be a kiosk of the service center or a mobile phone of the user. In either case, the computer system is in communication with the remote server.

Responsive to the user request and optionally responsive to information obtained from the user account, at step 125 the remote server is used to determine a solution to the user request. The solution may include an identification of equipment needed by the user, for example, to replace the user's existing equipment or to provide additional equipment, and the identification can be provided to the agent. The solution includes an identification of a selected locker located at the customer service center.

At step 130, the remote server is used to communicate the selected locker identification, e.g., locker number, and an unlock code to the user via the customer service session at the computer system. According to some embodiments, the selected locker may contain equipment for the user to satisfy the user request, and the computer system includes an interactive kiosk or a mobile device that the customer interacts with.

According to some embodiments, the remote server determines a solution to the user request by first determining required equipment that satisfies the user request, and the selected locker is then determined by scanning contents of several different lockers to locate a locker containing the required equipment. The contents of the lockers may be stored in a locker contents database accessible at the remote server. When new equipment is placed into a particular locker, the remote server can receive identifications of the new equipment and the particular locker, and can store the identifications into the locker contents database to keep the database contents current. Its items are placed into the lockers and removed from the lockers, and the contents database is updated accordingly.

According to some embodiments, a barcode is scanned to identify the equipment to be returned. Based on the barcode, the identification of a locker (e.g., a locker number) and an unlock code are transmitted to the remote customer service agent, and the agent transmits the unlock code to the corresponding locker to unlock the locker so it can be used to receive the item from the user. An agent can dynamically change the unlock code associated with a locker at any time. According to other embodiments, the identification of the locker and the unlock code are displayed on the display device of the kiosk or computer system, and the user enters the unlock code to unlock the locker. According to some embodiments, the unlock code is a string of numbers and/or characters for unlocking the selected locker, or a barcode that can be scanned to unlock the selected locker.

The user can also place old equipment into a locker, and the solution can include an identification of the old equipment. For example, the old equipment can be identified by scanning a bar code on the equipment to identify the equipment by model number, serial number, version number, etc. The remote server then communicates the identification of the old equipment, an identification of the selected locker, and optionally a work task for a worker at the customer center to verify that the old equipment is present in the selected locker. The work task item is sent to a representative at the customer service center. The remote server may also include a user account database that stores information related to a plurality of user accounts.

With regard to FIG. 1B, an exemplary sequence of computer-implemented steps 150 for automated unlocking and locking of an enclosure based on verified user credentials to dispense an item and/or accept an item from a user is depicted according to embodiments of the present invention. The steps 150 can be executed by an equipment management system, such as the system 200 depicted in FIG. 2, for example.

At step 155, user credentials such as an account number or a user name and password combination are received. The user credentials can be entered using an input device of a kiosk, for example. According to some embodiments, step 155 includes communicating the user credentials to a remote agent using the kiosk.

At step 160, the user credentials are transmitted to a local or remote server for verification. For example, the user credentials can be transmitted from the kiosk to the remote server, or the user credentials can be transmitted to the remote server by the remote agent.

At step 165, the remote server verifies the user credentials. For example, the remote server can access a database of user credentials and/or account information associated with user accounts, and the credentials can be compared against the information stored in the database.

At step 170A, a locker is unlocked responsive to the user credentials being verified successfully in step 165. The user can retrieve an item from the unlocked locker or place and item inside the unlocked locker to return the item. Step 170A can also include transmitting a status update to the remote server indicating that an item has been dispensed or accepted.

At step 170B, data associated with the item is received by scanning a barcode. For example, when an item is being placed in the locker by the user, the user scans the barcode before placing the item in the locker at step 170A. When a user is retrieving an item from the locker at step 170A, the barcode is scanned in step 170B after the item has been dispensed in step 170A. In other words, steps 170A and 170B can be performed in any order according to embodiments of the present invention.

At step 175 of FIG. 1B, data associated with a returned item can optionally be received by scanning a barcode. For example, step 170A can include unlocking a locker to dispense an item, and a different item can be placed in the same locker, for example, to return old equipment. Therefore, step 175 can include scanning the old equipment before the old equipment is placed in the locker.

At step 180, a receipt is provided to the customer including an identification of any returned or dispensed equipment. The receipt can be printed at the kiosk or sent to the user electronically, for example.

At step 185, the locker is automatically locked. According to some embodiments, step 185 includes dynamically changing the lock code when the locker is locked so that a new lock code must be used to unlock the locker.

### Interactive Service Center Kiosk for Dispensing and Accepting Equipment

With regard to FIG. 2, an exemplary equipment management system 200 is depicted according to embodiments of the present invention. The equipment management system 200 can automatically provide interactive customer service to unlock an enclosure of service center 210 for solving a service issue. Enclosures 220 may include lockers or other enclosures that can be selectively and automatically locked and unlocked according to an API using a kiosk 215 or other computer system in communication with a remote server 205. The remote server includes a locker contents database 240 and is in communication with a customer account database 235 for accessing and verifying customer account information. Some of the enclosures may be empty (e.g., enclosure 225) and used for accepting items or equipment that is returned by a customer. Other enclosures (e.g., enclosure 230) contain one or more items or equipment for solving a service issue. The customer can also take an item from an enclosure and replace the item with another item, such as an old or damaged item. The enclosures 220 include locks that are programmed using an API such that the locks can be locked and unlocked automatically and remotely, and the unlock code can be changed at any time. According to some embodiments, kiosk 215 is mounted directly on the enclosures 220. According to other embodiments, the individual enclosures of enclosures 220 include kiosks with interfaces. The kiosk 215 could also be a mobile phone or tablet.

In one exemplary embodiment, a customer provides relevant information (e.g., account or user identity information) using kiosk 215, and the information is verified by remote server 205. The remote server 205 may be located off-site or in a server room of the service center, for example. In another exemplary embodiment, the enclosures 220 are used in combination with a smartphone application executed by the customer to provide associated user information and/or account information. During a customer interaction with computer 215, an interface 245 is provided in computer 215 that allows the customer to interact with a remote assistant 260 or automated help application. According to some embodiments, the interface 245 includes an optical scanner for scanning a barcode associated with a specific piece or type of equipment. The kiosk 215 includes a speaker 250 and microphone 255 for enabling communication between the virtual assistant 260 and the customer.

After the information is received by the remote server 205, the remote server 205 communicates an enclosure identification (e.g., a locker number) and an unlock code to the agent, and the agent can unlock the respective enclosure using the unlock code. According to some embodiments, the unlock code is displayed on a display of a kiosk or smartphone application executed by the user, and the customer unlocks the selected locker by entering the unlock code or scanning a bar code or by any other suitable user input techniques.

The selected locker may be determined by scanning contents of several different lockers to locate a locker containing the required equipment, or accessing a locker contents database at the remote server. According to some embodiments, the selected locker is unlocked using an unlock code provided to the customer or the agent. The customer can then receive the new equipment from the unlocked enclosure and optionally place any old equipment into the locker to return the old equipment. If old equipment is placed in the enclosure, the enclosure can be closed and locked by the remote server to secure the returned item using a different unlock code. In other words, the code used to unlock each locker is dynamic and can be automatically or manually changed after the respective enclosure has been accessed by a customer.

According to some embodiments, a bar code is scanned when an item is placed in a locker, and the location of the item is stored in a locker contents database at the remote server. After an item has been taken from an enclosure, the locker contents database is updated and the system 200 can print a receipt or send a receipt to the customer electronically. Similarly, the system 200 can print a receipt or send a receipt to the customer electronically when an item is scanned and placed in an enclosure to return the item.

According to some embodiments, a user's identification is determined during an interactive session between a customer and an agent (e.g., a phone call, text chat, video chat, real-time messaging, etc.), or a communication between a customer and an automated service system (e.g., a chat bot or Interactive Voice Response system). Moreover, the customer can add items to a virtual shopping cart associated with the customer's account, and a computer system (e.g., a remote server) determines what equipment the customer needs based on the items in their shopping cart. According to some embodiments, the item or equipment selected to satisfy a need of the customer is determined according to the account history or prior customer service sessions of the customer.

### Automatic Unlocking of Equipment Locker and Tracking of Contents Thereof

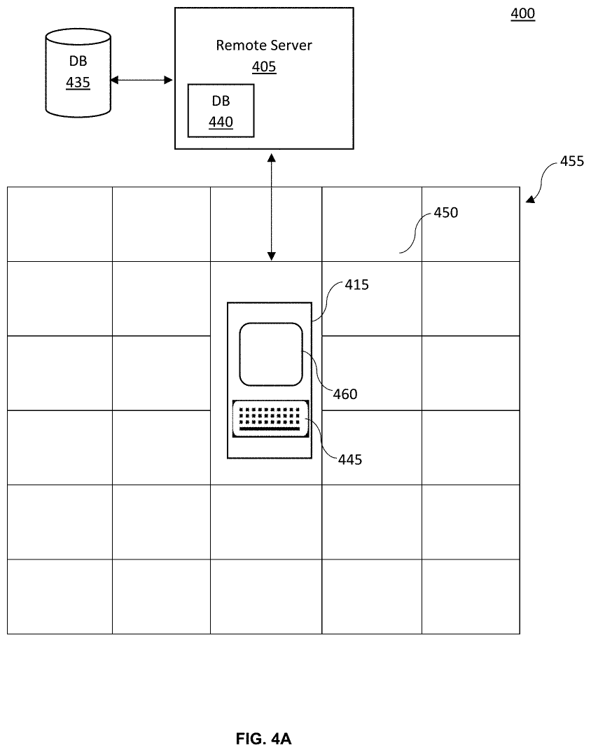

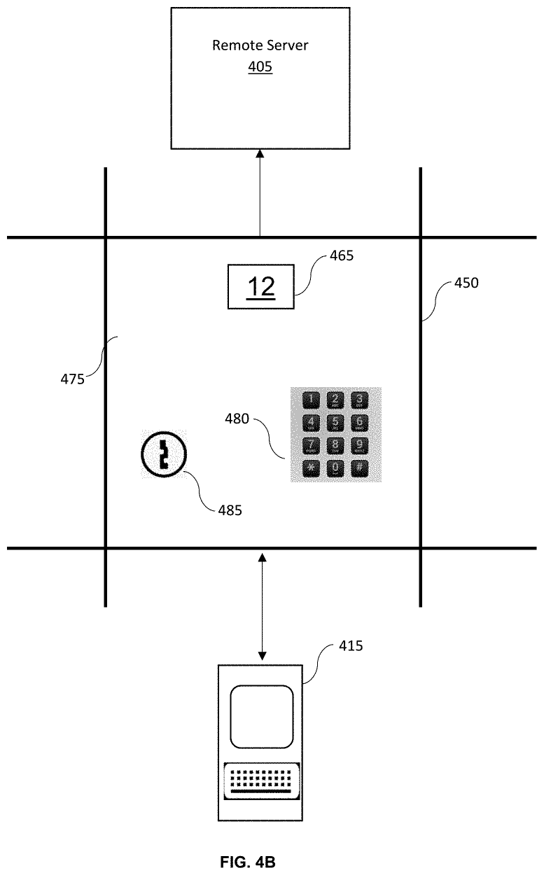

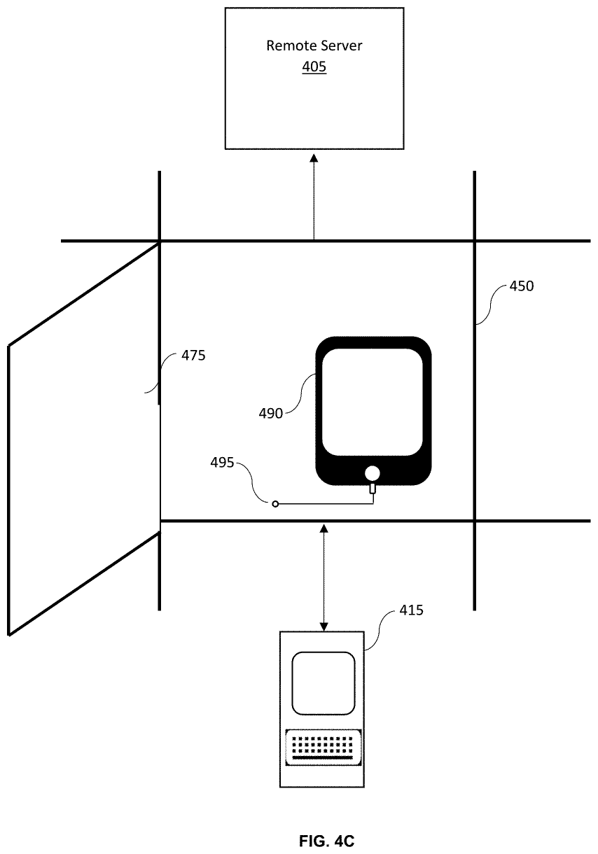

With regard to FIG. 3A, an exemplary sequence of computer-implemented steps 300 for automated unlocking of an equipment locker and tracking contents stored therein is depicted according to embodiments of the present invention. The steps 350 can be executed by an equipment management system, such as the system 400 depicted in FIG. 4A, for example.

At step 305, employee credentials such as a user name and password are received. The employee credentials can be entered using an input device of a kiosk, or can be determined by scanning an employee ID card using an input device (e.g., optical scanner or barcode reader) of the kiosk or by any other suitable user input mechanism.

At step 310, the employee credentials are transmitted from the kiosk to a remote server for verification.

At step 315, the remote server verifies the employee credentials. For example, the remote server can access a database of employee credentials associated with employees, and the credentials received from the kiosk can be compared against the credentials stored in the database.

At step 320, a locker is unlocked to dispense an item responsive to the employee's credentials being verified successfully in step 315. According to some embodiments, an employee is associated with a specific locker or piece of equipment, and the locker associated with the employee is automatically unlocked at step 320. According to other embodiments, any individual locker containing a suitable piece of can be unlocked at step 320 responsive to the employee's credentials being verified successfully in step 315. Step 320 can also include transmitting the status of the device to the remote server indicating that the item or equipment has been dispensed.

At step 325, it is determined that the item or equipment dispensed in step 320 has been returned. According to some embodiments, step 325 includes determining that the item or equipment dispensed in step 320 has been plugged in to a cable disposed in the locker (e.g., a USB cable). According to other embodiments, the item is determined to be returned when the employee provides their credentials using the kiosk to verify the employee's identity. Step 325 can include transmitting the status of the item or equipment to the remote server indicating that the item or equipment has been returned.

At step 330, responsive to determining that the item has been returned, the locker is automatically locked. According to some embodiments, step 330 includes dynamically changing the lock code when the locker is locked so that a new lock code must be used to unlock the locker.

Any of the steps 305-330 can include storing a date and/or time (e.g., timestamp) in a database (e.g., database 440 of FIG. 4). For example, a timestamp can be stored on the remote server to indicate when an item was dispensed and/or accepted by the equipment locker, when employee credentials were provided or verified, etc. The recoded date and time can be used to determine how long the equipment was checked out, for example.

With regard to FIG. 3B, an exemplary sequence of computer-implemented steps 350 for unlocking an equipment locker responsive to an unlock code entered at the locker and tracking contents stored therein is depicted according to embodiments of the present invention. The steps 350 can be executed by an equipment management system, such as the system 400 depicted in FIG. 4A, for example.

At step 355, employee credentials such as a user name and password are received by a computer system. The employee credentials can be entered using an input device of a kiosk (e.g., kiosk 415 of FIG. 4A), or can be stored on an employee ID card that is scanned by an input device of the kiosk.

At step 360, the employee credentials are transmitted from the kiosk to a remote server for verification.

At step 365, the remote server verifies the employee credentials. For example, the remote server can access a database of employee credentials associated with employees, and the credentials received from the kiosk can be compared against the credentials stored in the database.

At step 370, a locker identification (e.g., locker number) of a specific locker and an unlock code associated with the locker are displayed at a kiosk or other computer system responsive to a successful verification of the employee credentials at step 365. According to some embodiments, employees are associated with a specific locker or piece of equipment, and the locker associated with a specific employee is identified at step 370. According to other embodiments, any individual locker containing a suitable piece of equipment can be identified at step 370 responsive to the employee's credentials being verified successfully in step 365.

At step 375, the unlock code provided in step 370 is received at the locker identified in step 370. For example, the unlock code can be entered using a digital keypad (e.g., keypad 480 of FIG. 4B).

At step 380, the locker is automatically unlocked responsive to the unlock code being entered in step 375, and an item or equipment stored in the locker is dispensed or withdrawn from the locker. Step 380 can include transmitting a status of the item or equipment to the remote server indicating that the item or equipment has been dispensed.

At step 385, it is determined that the item or equipment dispensed in step 380 has been returned. According to some embodiments, step 385 includes determining that the item or equipment dispensed in step 320 has been coupled to a cable disposed in the locker (e.g., cable 495 of FIG. 4C). According to other embodiments, the item is determined to be returned when the employee provides their credentials using the kiosk to verify the employee's identity. Step 385 can include transmitting a status of the item or equipment to the remote server indicating that the item or equipment has been returned.

At step 390, responsive to automatically determining that the item has been returned, the locker is locked. According to some embodiments, step 390 includes dynamically changing the lock code when the locker is locked so that a new lock code must be used to unlock the locker.

Any of the steps 355-390 can also include storing a date and/or time (e.g., timestamp) in a database (e.g., database 440 of FIG. 4A). For example, a timestamp can be stored to record when an item was dispensed and/or accepted by the equipment locker, when employee credentials were provided or verified, etc. The recoded date and time can be used to determine how long the equipment was checked out, for example.

### Interactive Employee Kiosk for Dispensing and Tracking Equipment

With regard to FIG. 4A, an exemplary equipment management system 400 for managing equipment lockers 455 is depicted according to embodiments of the present invention. The equipment management system 400 can automatically dispense and accept equipment for authorized users. According to one embodiment, an employee provides credentials such as a user name and password using input device 445 (e.g., keyboard) of kiosk 415 to verify the employee's identity, and a respective locker (e.g., locker 450) is automatically unlocked to dispense an item (e.g., a tablet) for the employee. The user name and password entered can be verified using a database of employee credentials 435 accessible to remote server 405. An ID card associated with the employee can also be used to verify the identity of the employee, or as a secondary form of identification, according to some embodiments.

After verifying the employee credentials, an unlock code and a locker number can be displayed on the display screen 460 of kiosk 415. The employee can enter the unlock code at the respective locker, and the employee can take the item out of the locker, and the time at which the item is dispensed is stored in database 440 of remote server 405. According to some embodiments, the locker is automatically unlocked by the system 400 after the employee has verified their credentials using kiosk 415. The employee can later return the item to the locker, and returning the item can include plugging the item into a cable (e.g., USB cable 495 of FIG. 4C), for example, to charge the item and/or send and receive data with the remote server 405.

The system 400 can detect and record when the item is returned according to when the locker is unlocked or when the item is plugged in, for example. The system 400 stores the time that the item was returned in database 440. The employee can then close the locker after the item has been returned and the locker is automatically locked to prevent unauthorized access. According to some embodiments, the locker is automatically locked using a new unlock code after the item is returned.

The remote server 405 stores a database 440 for tracking the relevant status of items in lockers 445. For example, the database 440 can store which employee has checked out which equipment, how long the equipment has been checked out, when the item was checked out, and when the item was returned, among other possible information. Database 435 is accessible by remote server 405 and stores employee credentials for verifying the identity of an employee to unlock a locker for dispensing equipment.

As depicted in FIG. 4A, the kiosk 460 is integrated into the center of equipment lockers 455. According to some embodiments, the kiosk 460 is a free-standing computer system separate from the equipment lockers 455 and can be a smartphone or tablet.

FIG. 4B depicts an exemplary locker 450 that can be automatically unlocked for dispensing and tracking equipment according to embodiments of the present invention. In FIG. 4B, locker door 475 is in a closed/locked state. The locker 450 includes a locker identification 465 (e.g., a locker number) that uniquely identifies the locker among several lockers. Locker 450 can be automatically unlocked by kiosk 415, or can be unlocked by entering a specific code using digital keypad 480. The code can be changed dynamically and is verified by remote server 405. According to some embodiments, the locker 450 includes a traditional lock 485 that can be unlocked using a physical key which may be used as a backup or failsafe in the case of power failure, system downtime, etc.

FIG. 4C depicts an exemplary locker 450 that can be automatically unlocked for dispensing and tracking equipment according to embodiments of the present invention. In FIG. 4C, locker door 475 is in an open/unlocked state. Equipment 490 is stored in locker 450 and can be connected to a cable 495 to charge the equipment and/or send and receive data with remote server 405. The cable 495 can be a USB cable, lightning cable, or any other similar data or power cable. Remote server 405 can detect when the equipment 490 is returned according to when the locker door 475 is unlocked/opened or when the equipment 490 is plugged in to cable 495. When the locker door 475 is closed it can be automatically locked using a different unlock code to prevent unauthorized access.

### Exemplary Computer System

Embodiments of the present invention are drawn to electronic systems for authorizing and providing access to a locker or other secure enclosure, for example, to solve via automated systems a customer service issue identified by a customer service agent or to track and authorize the use of equipment. The following discussion describes one such exemplary electronic system or computer system can be used as a platform for implementing embodiments of the present invention.

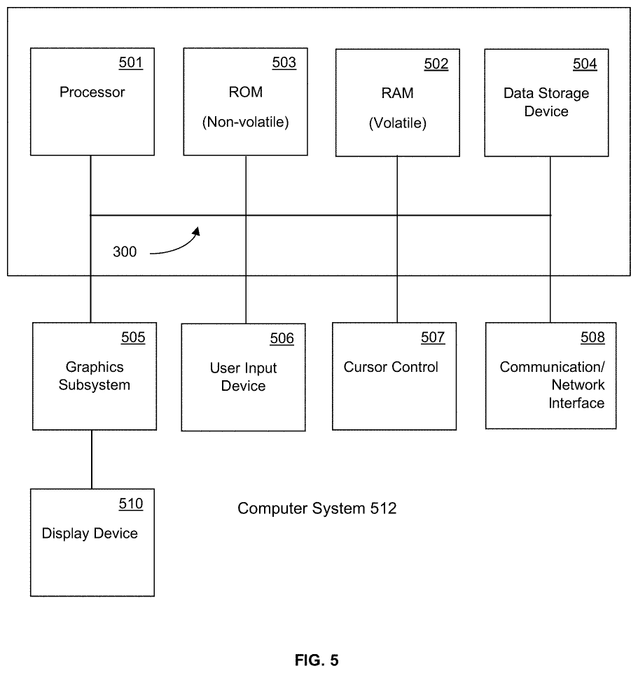

In the example of FIG. 5, the exemplary computer system 512 (e.g., a customer service system, kiosk, or remote server) includes a central processing unit (CPU) 501 for running software applications and optionally an operating system. Random access memory 502 and read-only memory 503 store applications and data for use by the CPU 501. Data storage device 504 provides non-volatile storage for applications and data and may include fixed disk drives, removable disk drives, flash memory devices, and CD-ROM, DVD-ROM or other optical storage devices. The optional user inputs 506 and 507 comprise devices that communicate inputs from one or more users to the computer system 512 (e.g., mice, joysticks, cameras, touch screens, and/or microphones).

A communication or network interface 508 includes a transceiver and allows the computer system 512 to communicate with other computer systems, networks, or devices via an electronic communications network, including wired and/or wireless communication and including an Intranet or the Internet (e.g., 802.11 wireless standard). The computer system 512 can be in communication with a remote server including one or more databases. Moreover, the computer system 512 can be in communication with one or more enclosures or lockers and can automatically lock and unlock the enclosures or lockers for an authorized user via signals transmitted from unit 508. The optional display device 510 may be any device capable of displaying visual information in response to a signal from the computer system 512 and may include a flat panel touch sensitive display, for example. The components of the computer system 312, including the CPU 501, memory 502/503, data storage 504, user input devices 506, and graphics subsystem 505 may be coupled via one or more data buses 500.

In the embodiment of FIG. 5, an optional graphics sub-system 505 may be coupled with the data bus and the components of the computer system 512. The graphics system may comprise a physical graphics processing unit (GPU) 505 and graphics/video memory. GPU 505 may include one or more rasterizers, transformation engines, and geometry engines, and generates pixel data from rendering commands to create output images. The physical GPU 505 can be configured as multiple virtual GPUs that may be used in parallel (e.g., concurrently) by a number of applications or processes executing in parallel, or multiple physical GPUs may be used simultaneously. Graphics sub-system 505 outputs display data to optional display device 510. The display device 510 may be communicatively coupled to the graphics subsystem 505 using HDMI, DVI, DisplayPort, VGA, etc.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Embodiments of the present invention are thus described. While the present invention has been described in particular embodiments, it should be appreciated that the present invention should not be construed as limited by such embodiments, but rather construed according to the following claims.

What is claimed is:

1. A method of automatically responding to a user request, the method comprising:
using a remote server to instantiate a customer service session with the user on a computer system located at a customer service center, wherein said customer service session is a software application performing the following:
rendering a user interface on the computer system, said user interface comprising a real-time displayed image and an audio rendering of a customer assistant;
responding to user input at said computer system, wherein said user input comprises an identification of said user, an identification of a user account associated with said user, and the user request; and
communicating information regarding said user request to said remote server;
responsive to said user request and information obtained from said user account, using said remote server to determine a solution to said user request, wherein said solution comprises an identification of a selected locker of a plurality of lockers located at said customer service center; and
using said remote server to communicate said selected locker identification and an unlock code to said user via said customer service session of said computer system, wherein said selected locker comprises required equipment for said user to satisfy said user request.

2. The method as described in claim 1 wherein said computer system is a kiosk located within said customer service center.

3. The method as described in claim 1 wherein said computer system is a mobile device associated with said user.

4. The method as described in claim 1 wherein said unlock code is a combination code to a lock associated with said selected locker.

5. The method as described in claim 1 wherein said using said remote server to determine a solution to said user request comprises:
determining said required equipment that satisfies said user request; and
determining said selected locker by scanning contents of said plurality of lockers to locate a locker containing said required equipment, wherein said contents of said plurality of lockers are represented in a locker contents database of said remote server.

6. The method as described in claim 5 further comprising responsive to new equipment being placed into a particular locker of said plurality of lockers, receiving identifications of said new equipment and said particular locker at said remote server and storing said identifications into said locker contents database of said remote server.

7. The method as described in claim 5 wherein said solution further comprises an identification of old equipment of said user to be placed into said selected locker by said user and further comprising said remote server communicating to a representative at said customer service center: said identification of said old equipment; an identification of said selected locker; and a work task to verify that said old equipment is present in said selected locker.

8. The method as described in claim 1 wherein said remote server comprises a user account database comprising a plurality of user accounts.

9. A method of automatically servicing a customer request, the method comprising:
using a remote server to initiate a customer service session with a customer on a computer system located at a customer service center, wherein said customer service session is a software application performing the following:
rendering a user interface on the computer system, said user interface comprising a real-time displayed image and an audio rendering of a customer assistant;
responding to user input at said computer system, wherein said user input comprises an identification of said customer, an identification of a customer account associated with said customer, and the customer request; and
communicating information regarding said customer request to said remote server;
responsive to said customer request and information gathered from said customer account, using said remote server to determine a solution to said customer request, wherein said solution comprises an identification of a selected locker of a plurality of lockers located at said customer service center;
using said remote server to communicate said selected locker identification to said customer via said customer service session; and
using said remote server to automatically unlock said selected locker of said plurality of lockers wherein said selected locker comprises required equipment for said customer to satisfy said customer request.

10. The method as described in claim 9 wherein said computer system is a kiosk located within said customer service center.

11. The method as described in claim 9 wherein said computer system is a mobile device associated with said customer

12. The method as described in claim 9 wherein said using said remote server to determine a solution to said customer request comprises:
Determining said required equipment that satisfies said customer request; and
determining said selected locker by scanning contents of said plurality of lockers to locate a locker containing said required equipment, wherein said contents of said plurality of lockers are represented in a locker contents database of said remote server.

13. The method as described in claim 12 further comprising responsive to new equipment being placed into a particular locker of said plurality of lockers, receiving identifications of said new equipment and said particular locker at said remote server and storing said identifications into said locker contents database of said remote server.

14. The method as described in claim 12 wherein said solution further comprises an identification of old equipment of said customer to be placed into said selected locker by said customer and further comprising said remote server communicating to a representative at said customer service center: said identification of said old equipment; an identification of said selected locker; and a work task to verify that said old equipment is present in said selected locker.

15. The method as described in claim 9 wherein said remote server comprises a user account database comprising a plurality of customer accounts.

16. A system to facilitate automatically servicing a customer request, the system comprising:
a remote server;
a plurality of lockable lockers located within a customer service center, said plurality of lockable lockers being in communication with the remote server;
a computer system in communication with the remote server and located at the customer service center, wherein the remote server is operable to initiate a customer service session with a customer on the computer system, wherein said customer service session is a software application performing the following:
rendering a user interface on the computer system, said user interface comprising a real-time displayed image and an audio rendering of a customer assistant;
responding to user input at said computer system, wherein said user input comprises an identification of said customer, an identification of a customer account associated with said customer, and the customer request; and
communicating information regarding said customer request to said remote server;
wherein, responsive to said customer request and information gathered from said customer account, said remote server operable to determine a solution to said customer request, wherein said solution comprises an identification of a selected locker of a plurality of lockers located at said customer service center;
wherein said remote server is also operable to communicate said selected locker identification to said customer via said customer service session; and
wherein further said remote server is operable to automatically unlock said selected locker of said plurality of lockers and wherein said selected locker comprises required equipment for said customer to satisfy said customer request.

17. The system as described in claim 16 wherein said computer system is a kiosk located within said customer service center.

18. The system as described in claim 16 wherein said computer system is a mobile device associated with said customer

19. The system as described in claim 16 wherein said remote server is operable to determine a solution to said customer request by:
determining said required equipment that satisfies said customer request; and
determining said selected locker by scanning contents of said plurality of lockers to locate a locker containing said required equipment, wherein said contents of said plurality of lockers are represented in a locker contents database of said remote server.

20. The system as described in claim 19 wherein said solution further comprises an identification of old equipment of said customer to be placed into said selected locker by said customer wherein said remote server is operable to communicate to a representative at said customer service center: said identification of said old equipment; an identification of said selected locker; and a work task to verify that said old equipment is present in said selected locker.

21. A system to dispense and track devices, the system comprising:
a remote server;
a plurality of lockable lockers in communication with the remote server; and
a computer system comprising an input device, wherein the computer system is in communication with the remote server, wherein the remote server is operable to validate user credentials and store a status of a plurality of devices stored in the plurality of lockable lockers, and wherein the computer system is operable to:
receive user credentials from the input device;
transmit the user credentials to the remote server for verification;
automatically unlock a first locker of the plurality of lockable lockers responsive to the remote server successfully verifying the user credentials;
transmit a first status of the device to the remote server, wherein the first status indicates that the device has been dispensed;
automatically determine that the device has been returned;
transmit a second status of the device to the remote server, wherein the second status indicates that the device has been returned; and
automatically lock the first locker responsive to determining that the device has been returned.

22. The system as described in claim 21, wherein the computer system is operable to determine that the device has been plugged into a cable disposed in the first locker to determine that the device has been returned.

23. The system as described in claim 21, wherein the computer system is operable to:
store a timestamp indicating when the device was dispensed; and
store a timestamp indicating when the device was returned.

24. The system as described in claim 21, wherein the computer system is operable to automatically change an unlock code used to lock the first locker.

25. A method of automatically tracking and dispensing a device, the method comprising:
receiving user credentials from an input device;
transmitting the user credentials to a remote server for verification;
automatically unlocking a locker responsive to the remote server successfully verifying the user credentials;
transmitting a first status of the device to the remote server, wherein the first status indicates that the device has been dispensed;
automatically determining that the device has been returned;
transmitting a second status of the device to the remote server, wherein the second status indicates that the device has been returned; and
automatically locking the locker responsive to determining that the device has been returned.

26. The method as described in claim 25, further comprising determining that the device has been plugged into a cable disposed in the locker to determine that the device has been returned.

27. The method as described in claim 25, further comprising:
storing a timestamp indicating when the device was dispensed; and
storing a timestamp indicating when the device was returned.

28. The method as described in claim 25, further comprising automatically changing an unlock code used to lock the locker.

29. The method as described in claim 25, further comprising:
displaying a locker identification of the locker and a corresponding unlock code on a display device responsive to the remote server successfully verifying the user credentials; and
receiving the unlock code at a digital keypad of the locker.
